(19) United States
(12) Patent Application Publication
(10) Pub. No.: US 2021/0379447 A1
(43) Pub. Date: Dec. 9, 2021

(54) Interactive exercise apparatus

(71) Applicant: Cheng-Kun Lee, Taichung City (TW)

(72) Inventor: Cheng-Kun Lee, Taichung City (TW)

(73) Assignee: Johnson HealthTech. Co., Ltd, Taichung City (TW)

(21) Appl. No.: 16/896,224

(22) Filed: Jun. 9, 2020

(51) Int. Cl. A63B 24/00; A63B 71/06

(52) U.S. Cl. CPC A63B 24/0075; A63B 24/0006; A63B 24/0062; A63B 2024/0015; A63B 2071/063; A63B 2071/0636; A63B 2071/0638; A63B 71/0622

(57) ABSTRACT

An interactive exercise apparatus includes a mirror display device, a control unit, and an identification unit. The mirror display device is able to reflect an image of a user and display workout information and video content with an exercise instructor performing an exercise for guiding the user to perform the exercise. The control unit is configured to control operation of the mirror display device. The identification unit is coupled to the control unit for identifying images of the user or exercise equipment. A workout list unit is coupled to the control unit for providing a list of fitness courses. The control unit is operable to control the mirror display device to show corresponding fitness courses for allowing the user to choose according to a movement posture of the user or exercise equipment the user used recognized by the identification unit.

### BACKGROUND

### 1. Field of the Invention

The present invention relates to an interactive exercise apparatus. More particularly, the present invention relates to a mirror display device which is able to provide a workout list for allowing a user to select.

### 2. Description of the Related Art

Indoor exercise is more and more popular in these days. More people are becoming aware of the need to exercise in order to maintain or improve their health and fitness. Since a person's schedule, weather, or other factors may prohibit the person from exercising outdoors, it is more convenient for the person to exercise indoors. Accordingly, indoor exercise apparatuses such as treadmills, stair exerciser apparatuses, steppers, exercise bikes provide such advantages for the person to use.

There is a fitness mirror product on the market, which can display a demonstration image on the mirror. When the user stands in front of the fitness mirror, the user can see his reflection and the user is able to perform workout with the demonstration movements on the mirror, as a fitness instructor provides real-time instructions. Some fitness mirrors users need to use their mobile phones to choose a fitness class they want to attend. However, it may be not convenient to take the mobile phone during workout and to choose fitness classes through the mobile phone.

The present invention has arisen to mitigate and/or obviate the disadvantages of the conventional method. Further benefits and advantages of the present invention will become apparent after a careful reading of the detailed description with appropriate reference to the accompanying drawings.

### SUMMARY

The present invention is directed to an interactive exercise apparatus that is capable of providing a workout list according to a movement posture of a user or exercise equipment the user used for allowing the user to choose.

According to one aspect of the present invention, an interactive exercise apparatus for guiding a user to perform exercises includes a frame, a mirror display device, a control unit, an identification unit, and a workout list unit. The mirror display device has a mirror mounted on the frame and a display disposed on a backside of the mirror and being visible through the mirror. The mirror is configured to reflect an image of the user opposite the mirror display device. The display is configured to show workout information and video content with an exercise instructor performing an exercise for guiding the user to perform the exercise. The control unit is configured to control operation of the mirror display device. The identification unit is mounted to the mirror display device and electrically coupled to the control unit. The identification unit is configured to detect and identify images of the user or exercise equipment. The workout list unit is coupled to the control unit for providing a list of fitness courses. Specifically, the control unit is operable to control the mirror display device to show corresponding fitness courses for allowing the user to choose according to a movement posture of the user or exercise equipment the user used recognized by the identification unit.

Preferably, the identification unit is operable to identifying posture and gesture of the user, so that the user can select one of the fitness courses displayed on the mirror display device through the posture or gesture of the user. Or the user is able to select one of the fitness courses displayed on the mirror by means of touching the mirror.

Preferably, the workout list unit is configured to provide a recommended workout list for allowing the user to choose, the recommended workout list including at least one of the fitness courses. Specifically, the recommended workout list includes a movement posture group and an exercise equipment group. The movement posture group includes a plurality of exercise items, each exercise item having at least one of the fitness courses. The exercise equipment group includes a plurality of exercise equipment items, each exercise equipment item having at least one of the fitness courses.

Preferably, the movement posture of the user that can be recognized by the identification unit includes one or more of stretching, aerobic, core muscles, yoga, boxing, Pilates or ballet.

Preferably, the exercise equipment that can be recognized by the identification unit includes one or more of dumbbell, barbell, bar, kettlebell, yoga mat, skipping rope, ball, or boxing gloves.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an interactive exercise apparatus in accordance with a preferred embodiment of the present invention;

FIG. 2 is a block diagram of the interactive exercise apparatus shown in FIG. 1;

FIG. 3 illustrates a user is performing a workout with a fitness course displayed on the interactive exercise apparatus;

FIG. 4 illustrates identification types of an identification of the interactive exercise apparatus;

FIG. 5 illustrates workout lists of a workout list unit of the interactive exercise apparatus;

FIG. 6 shows a user performing a workout through the interactive exercise apparatus;

FIG. 7 shows several recommended fitness courses shown in FIG. 6;

FIG. 8 shows several recommended fitness courses of a fitness equipment; and

FIG. 9 to FIG. 14 show different exercise types that can be identified by the interactive exercise apparatus.

### DETAIL DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically depicted in order to simplify the drawings.

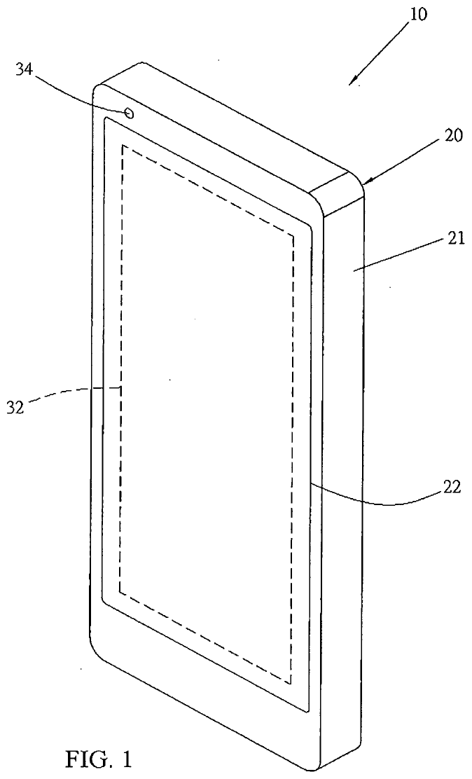

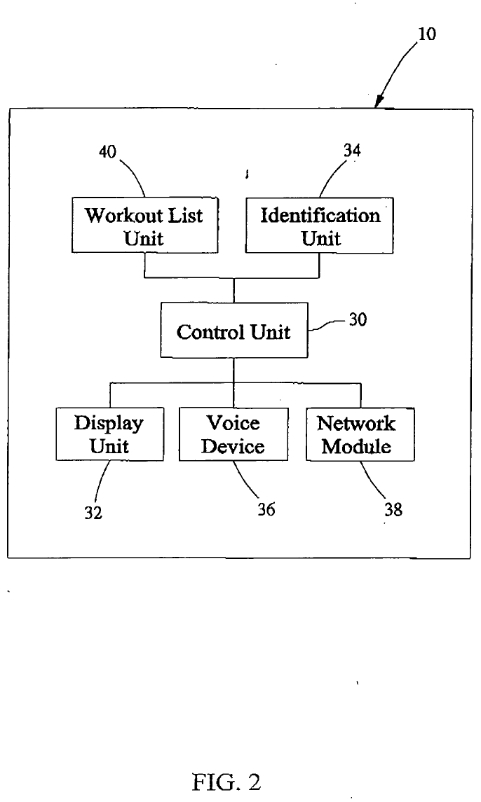

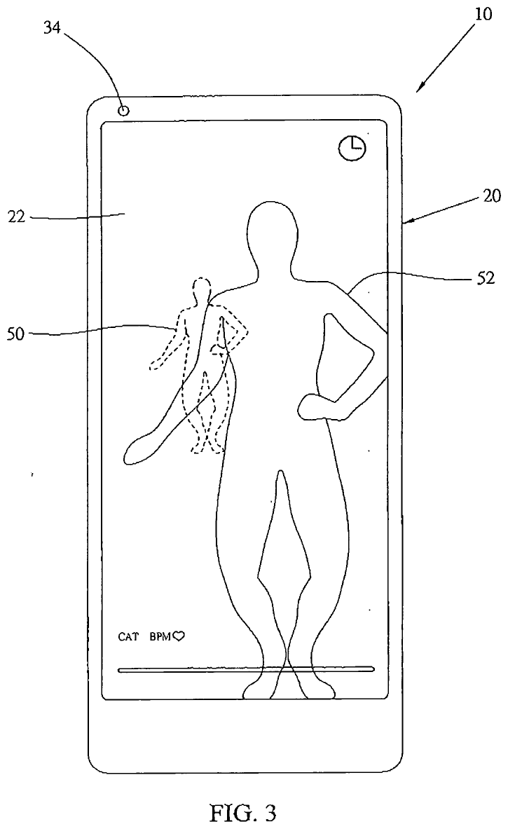

Referring to FIG. 1 through FIG. 2, an interactive exercise apparatus 10 (also referred to as a “smart mirror” hereinafter) is illustrated in accordance with a preferred embodiment of the present invention. The smart mirror 10 is capable of providing a workout list for allowing a user to select. The smart mirror 10 includes a mirror display device 20, a frame 21, a control unit 30, an identification unit 34, a voice device 36, a network module 38 and a workout list unit 40. The mirror display device 20 has a mirror 22 mounted on the frame 21 and a display 32 disposed on a backside of the mirror 22. The mirror 22 is configured to reflect an image of the user opposite the mirror display device 20. As shown in FIG. 3, the mirror 22 of the smart mirror 10 can present a guiding image of a fitness course. Preferably, to show live or recorded video of an instructor performing a specific workout, such that the user can follow the movement of the instructor to perform the same workout displayed on the mirror display device 20. Furthermore, the mirror 22 can reflect the image of the user so that the user can see his reflected image in the mirror 22.

Referring to FIG. 2, the control unit 30 is configured to mainly control operation of the mirror display device 20 and electrically connected to the display 32, the identification unit 34, the voice device 36, the network module 38 and the workout list unit 40. The control unit 30 has an arithmetic function, a comparison function and a judgement function. The control unit 30 is able to send an appropriate signal to the relevant device, module or unit to perform various functions of the smart mirror 10 after receiving and identifying the signal or information and being calculated. The control unit 30 has a built-in memory and storage including, but not limited to a hard disc drive (HDD), a solid-state drive (SSD), flash memory, random access memory (RAM), and a secure digital (SD) card. The built-in memory and/or storage may be used to store firmware and software such as driving program, operating system, application program for operation of the smart mirror 10. Besides, the built-in memory and/or storage of the control unit 30 may also be used to store other data including, but not limited to video content such as guiding videos of an instructor performing various exercises or workout activities, and/or exercise/workout programs.

In the preferred embodiment of the present invention, the display 32 may be an LCD, LED, or plasma display screen, which is disposed on the back of the mirror 22, and is used for displaying different information such as video content, images, graphics, or messages. The video content includes decomposition and explanation images of workout movements, and/or guiding images of continuous motion of workout demonstrations for allowing the user to emulate. The information includes general information (e.g., date, time, or any feedback words) and exercise information (e.g. heat rate, calories, elapsed time, exercise progress, statistic information, exercising target and achievement rate. The mirror 22 is a transparent mirror such that the images, videos or information displayed on the display 32 are visible through the mirror 22. Referring to FIG. 3, when the user stands before the mirror for performing exercises, the user can see his own mirrored image 52 and images (e.g. guiding images 50), graphics, or messages displayed on the display 32 at the same time. Therefore, the smart mirror 10 may allow users and/or instructors to interact with each other during the workout

The voice device 36 may include a speaker to output video content and audio to the user, so that the smart mirror 10 can provide different sounds or voices according to the usage state, for example, the prompting sounds, video sounds, or inspired words. Besides, the voice device 36 may also include a voice receiver to capture voices of the user, so that the user can input voice commands and/or voice inputs to the smart mirror 10.

The network module 38 may be a wire or wireless network module, so that the smart mirror 10 can be connected to a server, a cloud server and/or a smart device (e.g. a smart phone, a tablet, a computer) via the network so as to update and transmit data, and receive exercise courses. Moreover, the smart mirror 10 may include a Bluetooth module for communicating with other apparatuses with Bluetooth and transmitting data, and a power module for providing power to the smart mirror 10.

The identification unit 34 is mounted in the frame 21 for detecting and identifying the exercise equipment prepared by the user, the user's action posture, or the posture/gesture of the user, and transmitting the recognized or determined massage to the control unit 30. The control unit 30 will provide a workout recommendation list for the user. The identification unit 34 is coupled to or embedded in an image capturing device (such as a video camera), an optical sensor, an infrared (IR) sensor, thermographic camera or other sensing devices with function of image identification 341 for detecting or sensing the images of the user's body or exercise apparatuses.

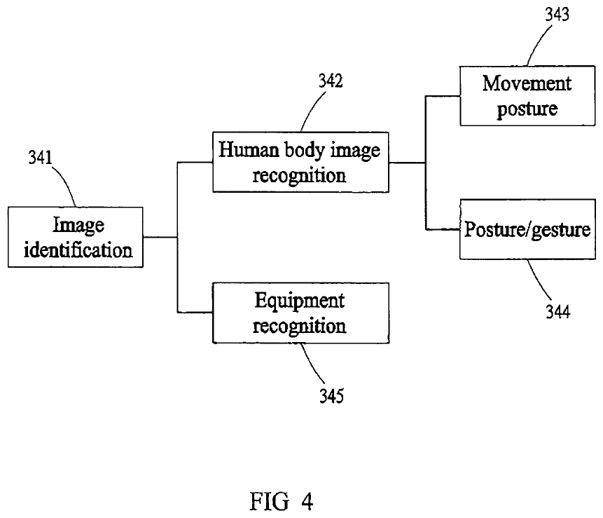

Referring to FIG. 4, the image identification 341 performed by the identification unit 34 includes: human body image recognition 342 and equipment recognition 345. The human body image recognition 342 includes, but not limited to, detecting and recognizing movement posture 343 and posture/gesture 344 of human body. The recognition of the movement posture 343 includes: identifying and detecting human movement posture, positions, and so on, for example, detecting the user's motion mode, and movement of the user's body such as movements of standing, sitting, lying, squatting, jumping, or forward, backward, leftward, or rightward movement; and detecting and recognizing position of the user (such as detecting the location of the user's head or eyes), and the movement type of limbs, including leg movements, hand movements, movement speed, etc. The recognition of posture/gesture 344 of human body is to detect the gesture of the hands or a specific posture, for example, the hand can be suspended and clicked twice. The equipment recognition 345 is to recognize exercise equipment including, but not limited to, dumbbells, barbell, bar, kettlebell, yoga mat, skipping rope, ball, boxing gloves, and so on. In the preferred embodiment, the control unit 30 (including its storage unit) is built with images or videos of a variety of workouts, human postures or gestures, and images of exercise equipment, so that the control unit 30 is able to compare the images recognized by the identification unit 34 with the built-in images.

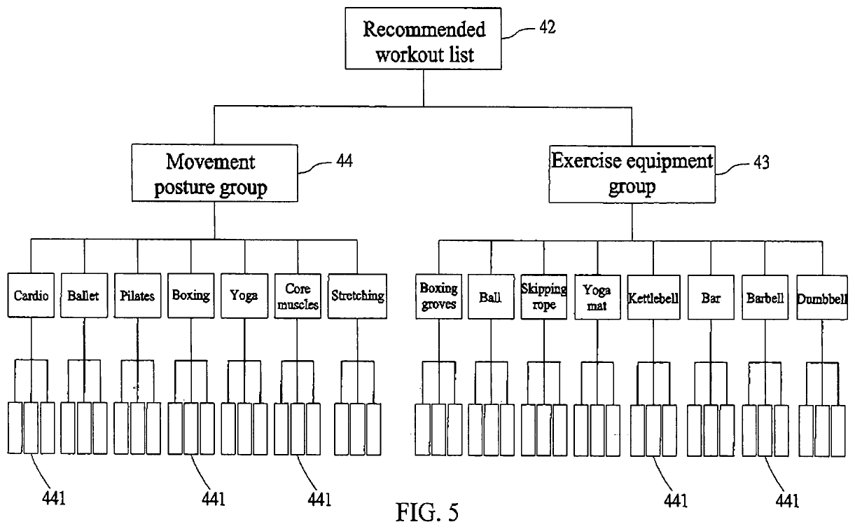

Referring to FIG. 5, the workout list unit 40 is configured to provide a recommended workout list 42, which can show workout items of a specific fitness course on the mirror 22 through the display 32 according to the recognition result of the identification unit 34. In the preferred embodiment of the present invention, the recommended workout list 42 is divided into two categories, corresponding to the types of the image identification 341, including an exercise equipment group 43 and a movement posture group 44. The exercise equipment group 43 has various kinds of fitness equipment items, including: dumbbells, barbell, bar, kettlebell, yoga mat, skipping rope, ball or boxing gloves. Each fitness equipment item lists several (one or more) fitness courses 441 for operating the respective fitness equipment. For example, when the identification unit 34 recognizes that the user selects dumbbells for workout, the workout list unit 40 will provide several recommended fitness courses 431 for workout with dumbbells and display the recommended fitness courses 431 on the mirror 22 for the user to choose. The user can select one of the recommended fitness courses 431 he wants by touching the mirror 22 of the smart mirror 10 or by specific operation gestures/postures (e.g. hand gestures) from a distance. The movement posture group 44 has various kinds of exercise items about common exercises, including: stretching, aerobic, core muscles, yoga, boxing, Pilates, ballet, etc. Each posture has its corresponding courses 441 for performing the respective exercise for users to choose.

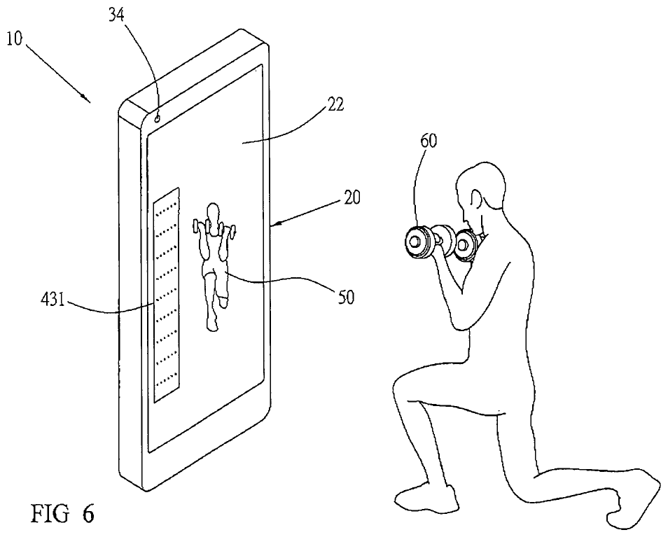

The user can use the smart mirror 10 to perform a variety of workouts, including: muscle endurance training, stretching, yoga, cardio/aerobic exercise, core workout, boxing, rope skipping, and other workouts to train muscle endurance of various parts of the body, core muscle groups, stretchability and cardio function. FIG. 6 shows a user who is located in front of the smart mirror 10 and wants to exercise with two dumbbells. When the identification unit 34 recognizes that the fitness equipment selected by the user is dumbbells 60, the control unit 30 will control the smart mirror 10 to show the fitness courses 431 of the dumbbell under the exercise equipment group 43 in the recommended workout list 42 according to the recognition result as recommended fitness courses for allowing the user to choose.

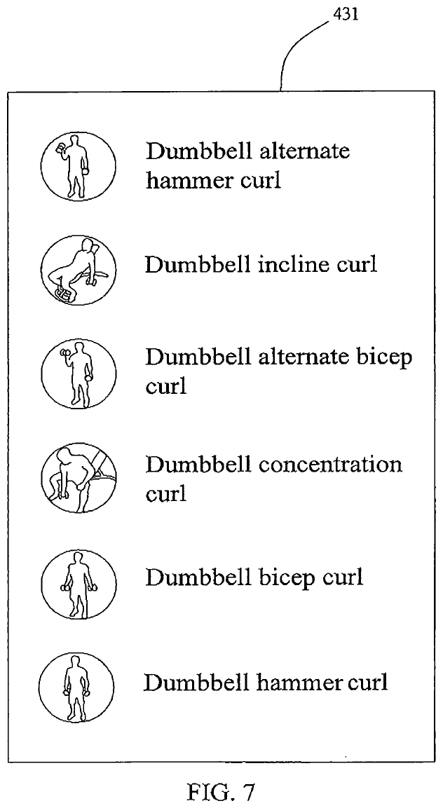

Referring to FIG. 7, which shows several dumbbell fitness courses 431 on the mirror 22, including: dumbbell alternate hammer curl, dumbbell incline curl, dumbbell alternate bicep curl, dumbbell concentration curl, dumbbell bicep curl, dumbbell hammer curls, etc. When the user wants to perform the recommended fitness courses 431 as shown in FIG. 7, the user can select a desired fitness course 431 by means of touching the mirror 22 of the smart mirror 10 or by specific operation gestures/postures. After the fitness course is selected, the control unit 30 of the smart mirror 10 is operable to display a guiding image 50 of the selected fitness course (as shown in FIG. 3), such that the user is able to emulate the movement of the guiding image 50 to perform the dumbbell workout.

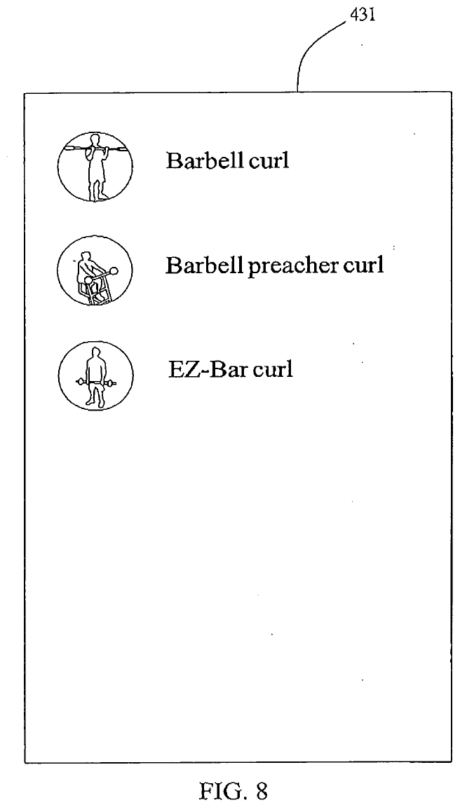

Similarly, when the identification unit 34 recognizes that the fitness equipment selected by the user is a barbell, the control unit 30 will control the smart mirror 10 to show the fitness courses 431 of the barbell under the exercise equipment group 43 in the recommended workout list 42 according to the recognition result as recommended fitness courses for allowing the user to choose. As shown in FIG. 8, the mirror 22 shows several barbell fitness courses 431 thereon.

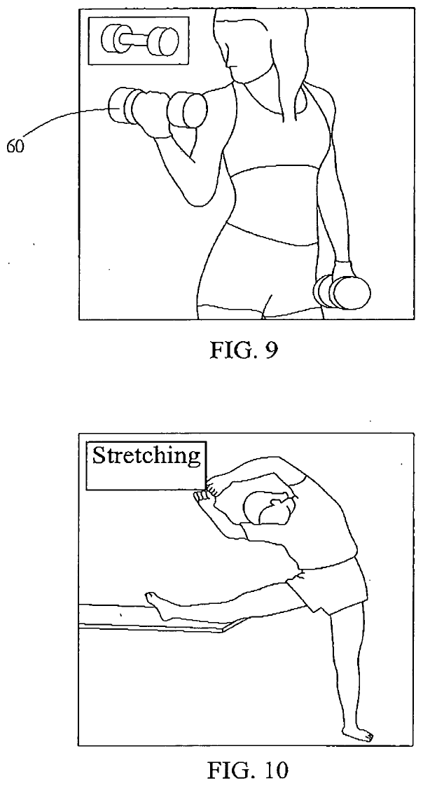

FIG. 9 to FIG. 14 show different exercise types that can be identified by the smart mirror 10. For example, FIG. 9 shows a user holding a pair of dumbbells, and the identification unit 34 recognizes that the fitness equipment is dumbbells, and then displaying a number of dumbbell fitness courses on the mirror 22 of the smart mirror 10 for the user to choose. Similarly, if the user uses other types of fitness equipment, such as barbells, kettlebells, yoga mats, skipping ropes, bars, balls, and boxing gloves, the smart mirror 10 will immediately display recommended fitness courses corresponding to the fitness equipment on the mirror 22 for the user to select after the identification unit 34 recognizes the fitness equipment; if the smart mirror 10 recognizes that the fitness equipment is a yoga mat or ball, the smart mirror 10 will recommend the user the fitness courses of yoga; and if the smart mirror 10 recognizes that the fitness equipment is boxing groves, the smart mirror 10 will recommend the user the fitness courses of boxing. After the user select a specific fitness course, the mirror will display a guiding image 50 or video content of the selected fitness course for allowing the user to perform the workout by following the guiding image 50 or video content.

As shown in FIG. 10, if the smart mirror 10 recognizes that the user is performing stretching exercise through the user's movement posture, the smart mirror 10 can recommend a number of upper body, lower body or full body stretching exercise courses 441 on the mirror 22 for the user to choose.

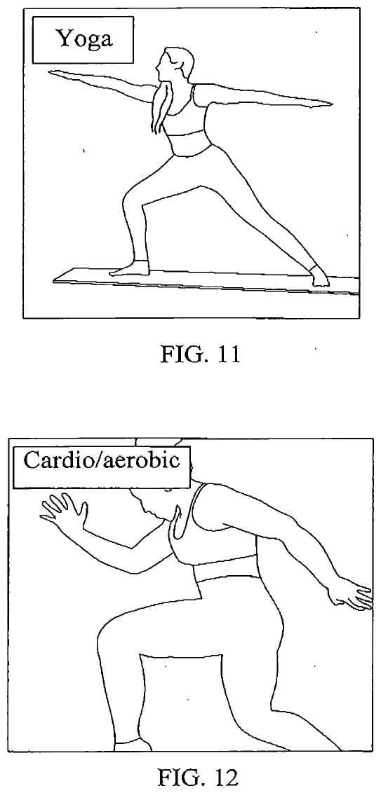

As shown in FIG. 11, if the smart mirror 10 recognizes that the user is performing yoga workout through the user's movement posture, the smart mirror 10 can recommend a number of yoga workout courses 441 on the mirror 22 for the user to choose. For example, hot yoga, rehab-yoga, gentle yoga, power yoga, prenatal yoga, vinyasa yoga, Ashtanga yoga, yoga stretch, ball yoga. etc.

As shown in FIG. 12, if the smart mirror 10 recognizes that the user is performing cardio/aerobic exercise through the user's movement posture, the smart mirror 10 can recommend a number of cardio/aerobic exercise courses 441 on the mirror 22 for the user to choose. For example, high-intensity interval training, high knees, jumping jacks, mountain climbers, jog in place, burpees, squat jumps, jump turns, etc.

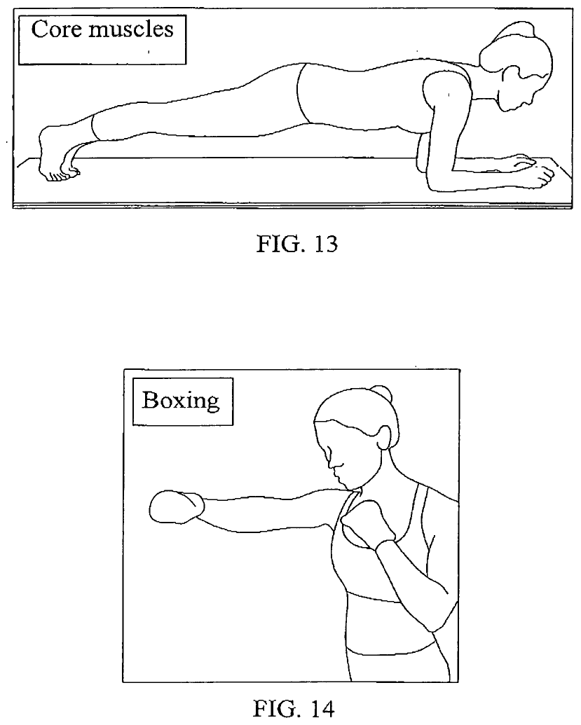

As shown in FIG. 13, if the smart mirror 10 recognizes that the user is performing core workout through the user's movement posture, the smart mirror 10 can recommend a number of core workout courses 441 on the mirror 22 for the user to choose. For example, plank, bridge, crunch, leg rises, cycling crunches, sitting twists, mountain climbers, etc.

As shown in FIG. 14, if the smart mirror 10 recognizes that the user is performing boxing exercises through the user's movement posture, the smart mirror 10 can recommend a number of boxing courses 441 on the mirror 22 for the user to choose. Other workout types such as Pilates or ballet can also be recognized by the smart mirror 10, and the smart mirror 10 can display corresponding fitness courses on the mirror 22 for the user to choose, such that the user can follow the guiding image 50 or video content displayed on the mirror 22 to perform the workout. Furthermore, the user may control the smart mirror 10 by using a smart phone or tablet to select the fitness courses on his own.

In the preferred embodiment of the present invention, the smart mirror 10 can directly determine exercise types that the user wants to do or the fitness equipment types that the user used through image detection and recognition, and directly and immediately list several fitness courses on the mirror for allowing users to choose. It makes the fitness activity more convenient, and there is no need to select a workout item through a mobile phone or other controllers.

Additionally, the smart mirror 10 may be coupled to other electrical exercise equipment, such as a treadmill, an exercise bike or a smart dumbbell. In general, the electrical exercise equipment may be wirelessly connected to the smart mirror 10 via Wi-Fi, Bluetooth, radio frequency (RF), etc. The electrical exercise equipment may be operable to control the smart mirror 10. For example, when the flywheel of the exercise bike is started to rotate, the smart mirror 10 will automatically turn on and execute flywheel-related course. Besides, the smart mirror may have functions of voice guidance, recording workout information, playing music, controlling resistance, and providing workout report.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An interactive exercise apparatus for guiding a user to perform exercises, comprising:
a frame;
a mirror display device having a mirror mounted on the frame and a display disposed on a backside of the mirror and being visible through the mirror, the mirror configured to reflect an image of the user opposite the mirror display device, the display configured to show workout information and video content with an exercise instructor performing an exercise for guiding the user to perform the exercise;
a control unit configured to control operation of the mirror display device;
an identification unit mounted to the mirror display device and electrically coupled to the control unit, the identification unit configured to detect and identify images of the user or exercise equipment; and
a workout list unit coupled to the control unit for providing a list of fitness courses;
wherein, the control unit is operable to control the mirror display device to show corresponding fitness courses for allowing the user to choose according to a movement posture of the user or exercise equipment the user used recognized by the identification unit.

2. The interactive exercise apparatus as claimed in claim 1, wherein the identification unit is operable to identifying posture and gesture of the user, so that the user can select one of the fitness courses displayed on the mirror display device through the posture or gesture of the user.

3. The interactive exercise apparatus as claimed in claim 1, wherein the user is able to select one of the fitness courses displayed on the mirror by means of touching the mirror.

4. The interactive exercise apparatus as claimed in claim 1, wherein the workout list unit is configured to provide a recommended workout list for allowing the user to choose, the recommended workout list including at least one of the fitness courses.

5. The interactive exercise apparatus as claimed in claim 4, wherein the recommended workout list comprises a movement posture group and an exercise equipment group, the movement posture group including a plurality of exercise items, each exercise item having at least one of the fitness courses; the exercise equipment group including a plurality of exercise equipment items, each exercise equipment item having at least one of the fitness courses.

6. The interactive exercise apparatus as claimed in claim 1, wherein the movement posture of the user that can be recognized by the identification unit includes one or more of stretching, aerobic, core muscles, yoga, boxing, Pilates or ballet.

7. The interactive exercise apparatus as claimed in claim 1, wherein the exercise equipment that can be recognized by the identification unit includes one or more of dumbbell, barbell, bar, kettlebell, yoga mat, skipping rope, ball or boxing gloves.

8. The interactive exercise apparatus as claimed in claim 1, wherein the identification unit comprises an image capture device, optical sensor or an infrared sensor.

9. The interactive exercise apparatus as claimed in claim 8, wherein the identification unit is disposed on the frame.

10. An interactive exercise system for providing a workout list according to a movement posture of a user or exercise equipment the user used, the interactive exercise system, comprising:
a mirror display device having a mirror and a display disposed on a backside of the mirror and being visible through the mirror, the mirror configured to reflect an image of the user opposite the mirror display device, the display configured to show workout information and video content with an exercise instructor performing an exercise for guiding the user to perform the exercise;
a control unit configured to control operation of the mirror display device;
an identification unit mounted to the mirror display device and electrically coupled to the control unit, the identification unit configured to detect and identify images of the user or exercise equipment; and
a workout list unit coupled to the control unit for providing a list of fitness courses;
wherein, the control unit is operable to control the mirror display device to show corresponding fitness courses for allowing the user to choose according to the movement posture of the user or the exercise equipment the user used recognized by the identification unit.

11. The interactive exercise system as claimed in claim 10, wherein the identification unit is operable to identifying posture and gesture of the user, so that the user can select one of the fitness courses displayed on the mirror display device through the posture or gesture of the user.

12. The interactive exercise system as claimed in claim 10, wherein the user is able to select one of the fitness courses displayed on the mirror by means of touching the mirror.

13. The interactive exercise system as claimed in claim 10, wherein the workout list unit is configured to provide a recommended workout list for allowing the user to choose, the recommended workout list including at least one of the fitness courses.

14. The interactive exercise system as claimed in claim 13, wherein the recommended workout list comprises a movement posture group and an exercise equipment group, the movement posture group including a plurality of exercise items, each exercise item having at least one of the fitness courses; the exercise equipment group including a plurality of exercise equipment items, each exercise equipment item having at least one of the fitness courses.

15. The interactive exercise system as claimed in claim 10, wherein the movement posture of the user that can be recognized by the identification unit includes one or more of stretching, aerobic, core muscles, yoga, boxing, Pilates or ballet.

16. The interactive exercise system as claimed in claim 10, wherein the exercise equipment that can be recognized by the identification unit includes one or more of dumbbell, barbell, bar, kettlebell, yoga mat, skipping rope, ball or boxing gloves.

17. The interactive exercise system as claimed in claim 10, wherein the identification unit comprises an image capture device, optical sensor or an infrared sensor.
